(19) United States
(12) Patent Application Publication
(10) Pub. No.: US 2002/0078069 A1
(43) Pub. Date: Jun. 20, 2002

(54) Automatic file name/attribute generator for object oriented desktop shells

(75) Inventor: Lawrence Martin Moore, Austin, TX (US)

Correspondence Address: Andrew J. Dillon, FELSMAN, BRADLEY, VADEN, GUNTER & DILLON, LLP, Lakewood on the Park, Suite 350, 7600B North Capital of Texas Highway, Austin, TX, 78731, US

(73) Assignee: International Business Machines Corporation

(21) Appl. No.: 09/737,335

(22) Filed: Dec. 15, 2000

(51) Int. Cl. G06F 17/30; G06F 17/21

(52) U.S. Cl. 707/200; 707/530

(57) ABSTRACT

A file naming attribute is associated with a document template, document control object, or similar document-defining structure which includes at least one text string for a constant or fixed portion of file names for documents created utilizing the document-defining structure and at least one argument for computing a variable portion of the file names. The argument may require calculation of a time and/or date or of an incremental number, or require that the user be prompted for input. When a new document is created utilizing the document-defining structure, the file naming attribute is employed to automatically generate a file name for a discrete file into which the new document may be saved. by concatenating text string(s) for the fixed portion(s) and the calculated or received text string(s) for the variable portions(s). A document control object may also specify access restrictions, distribution, and backup for the newly created document.

### BACKGROUND OF THE INVENTION

1. Technical Field

The present invention relates generally to file management in data processing systems and in particular to naming and manipulating files generated within a data processing system. Still more particularly, the present invention relates to automatically naming and manipulating files for documents generated utilizing a standard document structure such as a template, form or style sheet.

2. Description of the Related Art

In the real world, people tend to think of everything around them as objects. This is especially true for paper documents. Anyone performing a significant amount of paperwork will usually think of each piece of paper as a separate document or object. Object-oriented user interfaces work in much the same way. Not only are programs treated as separate objects, but data files are also treated as objects as well. If a user double-clicks on a data file which the system relates to a particular application, the application is loaded with that data file.

Data processing system users frequently have a need to prepare documents of generally the same type on a recurring

Operating systems and/or application suites usually facilitate generation of such recurring documents. Some operating systems, for example, allow users to create a new file of a particular recurring type by dragging and dropping an object from a template within the user interface. Popular application suites, such as Microsoft Office from Microsoft Corporation, Lotus SmartSuite from Lotus Development Corporation, and Corel OfficePerfect from Corel Corporation, each support similar templates, forms or style sheets for quickly generating a new document based on a recurring document structure.

Generally, each time a new document is created using such a template or form, the user must manually edit the document name in order to save the document as a discrete item within a separate file. If the object was dropped on the user interface “desktop,” by default the file will be saved within the system directory, and the user must manually edit the directory path. Manual entry of the file name, and manual selection of the directory path in which to save the document, may be unnecessarily troublesome for the user.

It would be desirable, therefore, to provide a mechanism for automatically generating file names and otherwise manipulating file attributes for documents produced from predefined templates, forms or stylesheets. It would further be advantageous for the file names which are generated to include some defining characteristic such as date or document version.

### SUMMARY OF THE INVENTION

It is therefore one object of the present invention to provide improved file management in data processing systems.

It is another object of the present invention to provide automatic file naming and manipulation within a data processing system.

It is yet another object of the present invention to provide automatic file naming and manipulation for documents generated utilizing a standard document structure such as a template, form or style sheet.

The foregoing objects are achieved as is now described. A file naming attribute is associated with a document template, document control object, or similar document-defining structure which includes at least one text string for a constant or fixed portion of file names for documents created utilizing the document-defining structure and at least one argument for computing a variable portion of the file names. The argument may require calculation of a time and/or date or of an incremental number, or require that the user be prompted for input. When a new document is created utilizing the document-defining structure, the file naming attribute is employed to automatically generate a file name for a discrete file into which the new document may be saved by concatenating text string(s) for the fixed portion(s) and the calculated or received text string(s) for the variable portions(s). A document control object may also specify access restrictions, distribution, and backup for the newly created document.

The above as well as additional objectives, features, and advantages of the present invention will become apparent in the following detailed description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts a block diagram of a data processing system of a preferred embodiment of the present invention;

FIG. 2 is a portion of a user interface including user controls for employing a template and automatically generating file names for documents created utilizing the template in accordance with a preferred embodiment of the present invention;

FIG. 3 depicts a high level flow chart for a process of automatically generating file names for a document created using a template in accordance with a preferred embodiment of the present invention; and

FIGS. 4A-4B are high level flow charts for processes of automatically manipulating documents utilizing a document control object in accordance with a preferred embodiment of the present invention.

### DETAILED DESCRIPTION

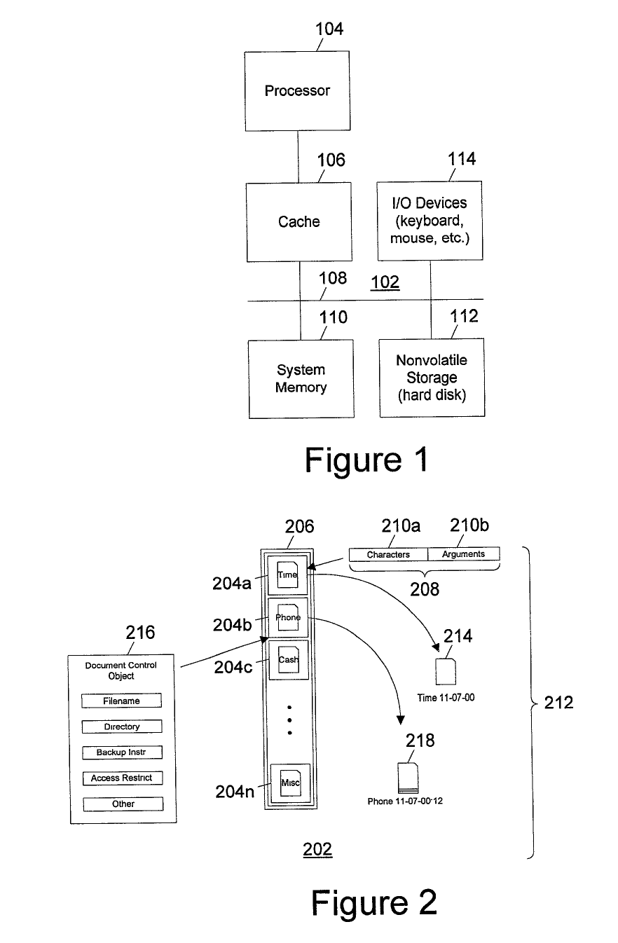

With reference now to the figures, and in particular with reference to FIG. 1, a block diagram of a data processing system in which a preferred embodiment of the present invention is depicted. Data processing system 102 includes a processor 104 coupled via a cache 106 to a system bus 108. Connected to the system bus 108 are conventional memory devices including a system memory 110, typically a random access memory, and a set of nonvolatile read-only memory (ROM) and/or erasable, electrically programmable read only memory (EEPROM) devices (not shown).

Also attached to system bus 108 are nonvolatile storage 112 such as a hard disk drive and a set of user input/output (I/O) devices 114, which would typically include a keyboard and a mouse or other cursor-control (“pointing”) device. Other storage media, such as a CR-ROM or DVD drive, floppy disk drive, and the like may also be employed within data processing system 102, together with other user I/O devices such as a microphone, speakers/headphones, and the like. The remaining details of construction and of operation of data processing system 102 are well known in the relevant art, and only so much of the operation as is required for an understanding of the present invention will be described herein.

Data processing system 102 includes a number of templates defining the structure of documents which a user wishes to produce on a recurring basis. (As used herein, “template” refers to any template, form, style sheet, or other data structure which defines a predetermined document structure.) An application or operating system utility executing within data processing system 102 allows the user to create new documents having the desired structure or layout, which may be modified by the user to include unique or new data and then saved as a discrete document, separate from (although possibly linked to) the template. One or more file names and other file attributes for the document are automatically created as described in further detail below.

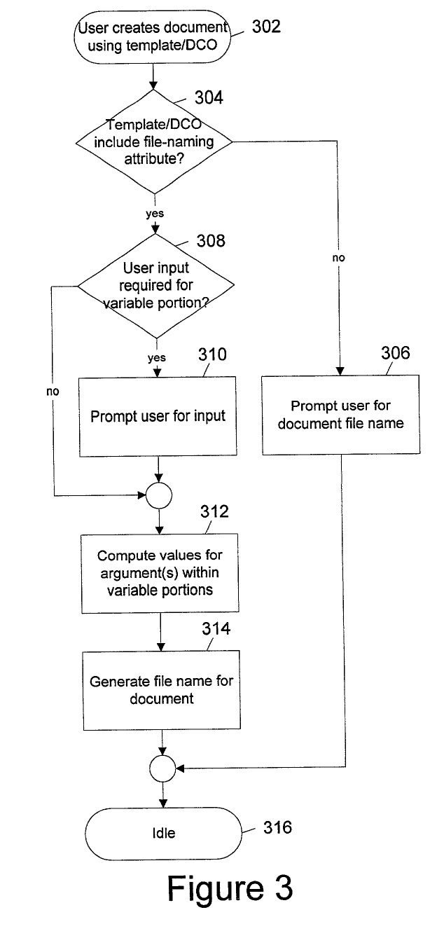

Referring to FIG. 2, a portion of a user interface including user controls for employing a template and automatically generating file names for documents created utilizing the template in accordance with a preferred embodiment of the present invention is illustrated. User interface 202 includes a set of templates 204a-204n, which may be disposed, for example, on a floating tool bar 206, or on a “quick start” menu or in any other user control within the user interface 202.

In one embodiment of the present invention, each template 204a-204n has an associated template or file name attribute 208 which includes a constant portion 210a and a variable portion 210b. The constant portion 210a may contain any number of characters and/or combinations of characters; the variable portion 210b contains special arguments utilized to cause the system to automatically generate text when the object is created. The generated text may be, for example, the current date, the current time, a user input, and/or an incremental numerical value. The method for automatically generating text for the special argument is preferably part of the class for the templates 204a-204n.

When a template 202a-202n is dragged and dropped onto the “desktop” or working portion 212 of user interface 202, a new document (and a corresponding file) is created and automatically named based on the template name 208 by generating the text from the special argument and utilizing that text as a portion of the file name. Thus, for example, if the template “Time” 202a, where template includes the filename attribute “`Time′&Date”, is dragged and dropped onto the desktop area 212, a new document/file 214 is created and automatically named based on the constant portion “Time” and the variable portion calculated from the current date (e.g., “Time 11-07-00”). Both text string within the constant portion 210a and the text string value calculated from the user-specified argument for the variable portion 210b must, of course, conform to any file naming limitations of the underlying operating system (e.g., restricted use of special characters, etc.). Rather than calculating the variable portion from some value such as date, time, or incremental number, the argument may instead prompt the user for input. In this manner, the manual editing required by the user is at least reduced to entering a text string for the variable portion.

In another embodiment of the present invention, a template may be associated with a document control object 216. File name attribute 208 is actually a special case of a document control object 216, one having control over only a limited range of file attributes. The document control object 216 is a class or executable which manipulates the created data file 218 in any manner which the user wishes. The user writes a set of instructions for the document control object 216 (in Java, for example). Each time the document control object 216 is activated (by creation of a new data file 218, for instance), the specific instructions contained therein are followed in setting attributes for data file 218.

The document control object 216 includes a user interface and is displayed as an object on the desktop. The document control object 216 makes work easier for the user who works with many files which share some commonality by removing much of the tedious work which the user would otherwise have to perform manually.

As a specific example, assume that a student wished to keep notes on the following classes: History, Math, Science, and English. The student uses WordPerfect to type the notes in outline format. In addition, the student would like the following:

Rather than having all notes stored in one common directory (as is common with most word processors), the student would like to have a series of subdirectories under a “\CLASSES” directory, one for each class.

The student would like to select a class from a list of classes associated with the file, such that every time the student creates a new data file associated with the document control object, a listbox appears with a list of classes.

The student would like a file name to be automatically generated for each new data file which is created, where the file name(s) follow the following structure:

X_[H|M|S|E]_[DATE]_[SEQ.NUM]_[EXTRA].wp, where “X” is a hard coded string (e.g., “Notes”) with all file names beginning with that string; [H|M|S|E] represent History, Math, Science, and English, respectively, with one of these letters being automatically entered into the title depending on which class the student selects; [DATE] is the date on which the file was created; [SEQ.NUM] is a sequential number, the value of which is incremented each time a new file is created, to ensure that all file names are unique; and [EXTRA] is a series of characters which the student may manually enter into a message box appearing each time the student creates a new files, prompting the user for input.

In addition, each section of the titles are separated by underscores, the files are automatically stored in appropriate class directories, and all files created should be capable of being easily backed up.

Under the prior art, in order to achieve the above result the student would be required to manually create a series of subdirectories under “\CLASSES”, one for each class; start the word processor application; create a new document, manually setting the format of that document to outline; enter the notes; when ready to save the document, manually specify the directory in which to store the document and manually enter the file name to the specifications above; when the semester is over, the student must manually move all of his notes to a CD-ROW for backup, then manually clean out the subdirectories under “\CLASSES” to make room on the hard drive for the next semester's classes.

With the present invention, the student creates a template document utilizing the word processor and codes a new document control object to associate with the template document. The document control object includes the name of the directory for each class, the string of the classes to be displayed in a listbox, and the file name template. When the student wishes to create a new set of notes, he double clicks on the template. A listbox appears with a list of classes from which the user makes a selection (e.g., “Math”). The document control object creates a new data file by copying the template document to the math subdirectory. If the subdirectory does not already exist, the subdirectory is automatically created.

The filename is now created. Since the user specifically wishes to enter some text manually for a portion of the filename, the document control object prompts the user to enter some characters. Assuming that the user entered “JL”, that the created data file is the first in the series created by the document control object, and that the file was created on Mar. 1, 2000, the document control object would generate the filename “X_M_{—}030100_{—}1_JL.wp” for the document. The document is opened utilizing the associated word processor application and the user may enter his notes.

At the end of the semester, the student may employ the document control object to make a selection which will back up all of the notes. Since the document control objet tracks all of the files created utilizing the document control object, the document control object is able to automatically move all of the files (including the subdirectories) to a writable CD-ROM for storage, emptying the \CLASSES directory for data for the next semester.

The document control object need only be coded once to operate for multiple semesters, with the student required only to provide a list of classes each semester by having the document control object read in a new data file containing a list of all classes for the current semester. In addition, coding of the document control object may be made as easy as possible by providing a series of Java classes implementing specific functions for the document control object, while allowing individual customization by permitting additional Java classes to be written.

The document control object may be programmed to perform more than just file naming. Data files may be automatically moved from user to user(s) via e-mail and the like, access may be restricted to particular users, and data files may be automatically archived and/or deleted after specified periods of time.

The class for the template, the document control object, or the file management system of the underlying operating system may also provide special handling for documents created from the same template/document control object. For example, a single icon (e.g., a representation of a stack of papers) may be employed to represent all documents created utilizing the same template/document control object within a user interface display, with the most recently edited document being the default and named below the icon. A “find” utility may be provided to enable a user to locate a particular document within the group, either before or during opening the document for editing.

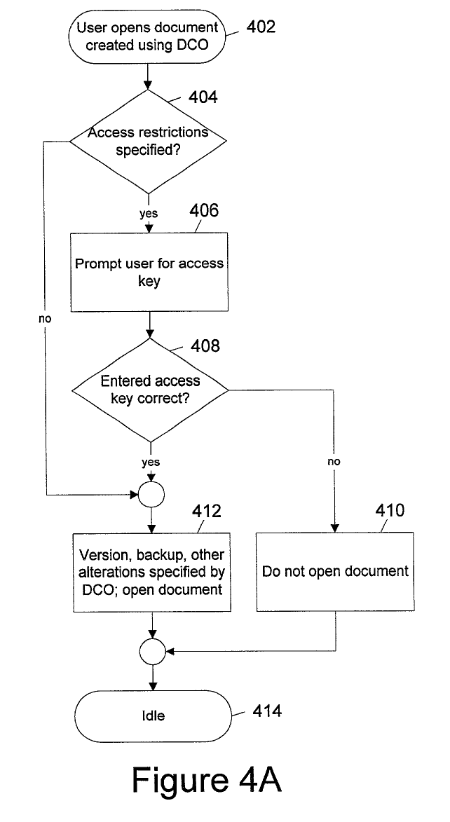

With reference now to FIG. 3, a high level flow chart for a process of automatically generating file names for a document created using a template or document control object in accordance with a preferred embodiment of the present invention is depicted. The process begins at step 302, which depicts a user creating a document utilizing a template/document control object (DCO). The process first passes to step 304, which illustrates a determination of whether the template or document control object employed has a document file naming attribute, including at least one fixed or constant portion and at least one variable portion, set by the user. If not, the process proceeds to step 306, which depicts prompting the user for a document file name.

If the template or document control object employed by the user includes a document file naming attribute, the process proceeds instead from step 304 to step 308, which illustrates a determination of whether user input is required for the document file name. If so, the process proceeds to step 310, which depicts prompting the user for input. If not, however, or once user input is received, the process proceeds to step 312, which illustrates calculating the text string value(s) for any variable portions (argument) of the user-specified document file naming attribute.

The process then proceeds to step 314, which depicts generating a document file name utilizing the text string within the constant portion(s) and the values received or computed for the variable portions. The document may then be saved with the resulting file name, within the subdirectory specified in the document control object (if any). The process then passes to step 316, which illustrates the process becoming idle until another document is created utilizing a template or document control object.

“Compound” documents may require multiple files of different types, such as a word processing file and a spreadsheet file. In such instances, the automatic file naming process of the present invention may still be employed, with each file being named according to the template file naming attribute and with file extensions employed to designate the document portion or type contained therein.

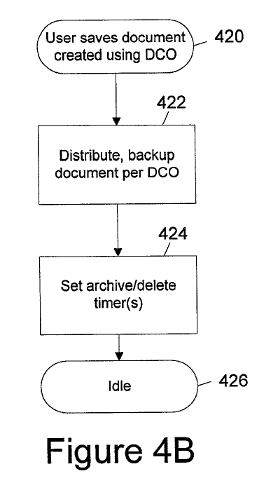

Referring to FIGS. 4A and 4B, high level flow charts for processes of automatically manipulating documents utilizing a document control object in accordance with a preferred embodiment of the present invention are illustrated. FIG. 4A illustrates a process of opening a document created by a document control object. The process begins at step 402, which illustrates a document created utilizing a document control object being opened. The process first passes to step 404, which depicts a determination of whether any access restrictions are set by the document control object. If so, the process proceeds to step 406, which illustrates prompting the user for entry of the access key (password).

The process next passes to step 408, which depicts a determination of whether the access key entered by the user is valid. If not, the process proceeds to step 410, which illustrates not opening the document. If so, however, the process proceeds instead to step 412, which depicts performing any versioning, backup, or other alteration (e.g., starting a new document section) which may be specified by the document control object, then opening the document within the appropriate application. The process then passes to step 414, which illustrates the process becoming idle until another document created utilizing a document control object is opened by the user.

FIG. 4B illustrates a process for saving a document created utilizing a document control object. The process begins at step 420, which illustrates a user saving a document created utilizing a document control object. The process passes first to step 422, which depicts performing distribution of the document and creating backups as specified by the document control object. The process passes next to step 424, which illustrates setting timers for future archiving or deletion of the document as specified by the document control object. The process then passes to step 426, which depicts the process becoming idle until a document created utilizing a document control object is again saved by a user.

The present invention allows file names to be automatically generated for a document created by a user from a template or document control object, making work easier for the user who is no longer required to manually select and enter a file name. The greatest benefit will be for users who must create files a generally similar type on a recurring basis (e.g., daily, weekly, monthly, etc.). Rather than being required to invoke an application and create a file name (usually using the template to define the file name) and modify the content for the new document, all the user is required to do is specify naming criteria for the template once, then utilize the template to create a new document. The file name is automatically generated.

Document control objects in accordance with the present invention allow the user to provide specific instructions regarding a document or group of documents, including file naming, storage (directory) location, automatic backup or distribution, and access restriction. Different document control objects may be associated within different groups of documents so that each document group has individual treatment.

It is important to note that while the present invention has been described in the context of a fully functional data processing system and/or network, those skilled in the art will appreciate that the mechanism of the present invention is capable of being distributed in the form of a machine usable medium of instructions in a variety of forms, and that the present invention applies equally regardless of the particular type of signal bearing medium used to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and CD-ROMs, and transmission type mediums such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of naming files, comprising:
responsive to a user creating a new document utilizing a document defining structure, determining whether the document defining structure includes a file naming property for automatic file naming;
responsive to determining that the document defining structure includes a file naming property for automatic file naming, generating a file name from a fixed text string within the file naming property and a text string derived from an argument within the file naming property; and
automatically naming a file for the document with the generated file name.

2. The method of claim 1, further comprising:
deriving the text string derived from the argument within the file naming property using at least one of the following:
determining a current date;
determining a current time;
calculating an incremental value; and
prompting a user for input.

3. The method of claim 1, wherein the step of generating a file name from a fixed text string within the file naming property and a text string derived from an argument within the file naming property further comprises:
concatenating the fixed text string and the text string derived from the argument.

4. The method of claim 1, wherein the step of generating a file name from a fixed text string within the file naming property and a text string derived from an argument within the file naming property further comprises:
computing a value for one or more arguments within the file naming property.

5. The method of claim 4, wherein the step of generating a file name from a fixed text string within the file naming property and a text string derived from an argument within the file naming property further comprises:
concatenating a plurality of text strings with computed values for one or more arguments in a predefined manner specified within the file naming property.

6. The method of claim 1, further comprising:
responsive to determining that the document defining structure includes a file naming property for automatic file naming, prompting the user for a file name for the document.

7. The method of claim 1, further comprising:
automatically saving the document into the file with the generated file name.

8. A system for naming files, comprising:
means, responsive to a user creating a new document utilizing a document defining structure, for determining whether the document defining structure includes a file naming property for automatic file naming;
means, responsive to determining that the document defining structure includes a file naming property for automatic file naming, for generating a file name from a fixed text string within the file naming property and a text string derived from an argument within the file naming property; and
means for automatically naming a file for the document with the generated file name.

9. The system of claim 8, further comprising:
means for deriving the text string derived from the argument within the file naming property using at least one of the following:
determining a current date;
determining a current time;
calculating an incremental value; and
prompting a user for input.

10. The system of claim 8, wherein the means for generating a file name from a fixed text string within the file naming property and a text string derived from an argument within the file naming property further comprises:
concatenating the fixed text string and the text string derived from the argument.

11. The system of claim 8, wherein the means for generating a file name from a fixed text string within the file naming property and a text string derived from an argument within the file naming property further comprises:
means for computing a value for one or more arguments within the file naming property.

12. The system of claim 11, wherein the means for generating a file name from a fixed text string within the file naming property and a text string derived from an argument within the file naming property further comprises:
means for concatenating a plurality of text strings with computed values for one or more arguments in a predefined manner specified within the file naming property.

13. The system of claim 8, further comprising:
means, responsive to determining that the document defining structure includes a file naming property for automatic file naming, for prompting the user for a file name for the document.

14. The system of claim 8, further comprising:
means for automatically saving the document into the file with the generated file name.

15. A computer program product of naming files, comprising:
responsive to a user creating a new document utilizing a document defining structure, determining whether the document defining structure includes a file naming property for automatic file naming;
responsive to determining that the document defining structure includes a file naming property for automatic file naming, generating a file name from a fixed text string within the file naming property and a text string derived from an argument within the file naming property; and
automatically naming a file for the document with the generated file name.

16. The computer program product of claim 15, further comprising:
instructions for deriving the text string derived from the argument within the file naming property using at least one of the following:
determining a current date;
determining a current time;
calculating an incremental value; and
prompting a user for input.

17. The computer program product of claim 15, wherein the instructions for generating a file name from a fixed text string within the file naming property and a text string derived from an argument within the file naming property further comprise:
instructions for concatenating the fixed text string and the text string derived from the argument.

18. The computer program product of claim 15, wherein the instructions for generating a file name from a fixed text string within the file naming property and a text string derived from an argument within the file naming property further comprise:
instructions for computing a value for one or more arguments within the file naming property.

19. The computer program product of claim 18, wherein the instructions for generating a file name from a fixed text string within the file naming property and a text string derived from an argument within the file naming property further comprise:
instructions for concatenating a plurality of text strings with computed values for one or more arguments in a predefined manner specified within the file naming property.

20. The computer program product of claim 15, further comprising:
instructions, responsive to determining that the document defining structure includes a file naming property for automatic file naming, for prompting the user for a file name for the document.

21. The computer program product of claim 15, further comprising:
instructions for automatically saving the document into the file with the generated file name.

22. A method of controlling documents, comprising:
defining a document control object for one or more documents, the document control object specifying at least one of file naming, storage location, automatic backup, distribution, and access restriction;
employing the document control object to set properties for a document created utilizing the document control object; and
employing the document control object in opening or saving documents created utilizing the document control object.

23. The method of claim 22, further comprising:
defining a first document control object for a first group of documents, the first document control object specifying at least one of file naming, storage location, automatic backup, distribution, and access restriction for the first group of documents; and
defining a second document control object for a second group of documents, the second document control object specifying at least one of file naming, storage location, automatic backup, distribution, and access restriction for the second group of documents,
wherein at least one parameter for file naming, storage location, automatic backup, distribution, and access restriction within the second document control object differs from a corresponding parameter within the first document control object.
